(19) United States
(12) Patent Application Publication
(10) Pub. No.: US 2001/0031376 A1
(43) Pub. Date: Oct. 18, 2001

(54) Aluminum alloy composition and process for impact extrusion of long-necked can bodies

(76) Inventors: Clarence W. Fulton, Ontario (CA); Delwyn L. Forrest, Ontario (CA)

Correspondence Address: INGRID E. SCHMIDT, GOWLING LAFLEUR HENDERSON LLP, 120 KING STREET WEST, SUITE 560, PO BOX 1045, LCD 1, HAMILTON, ON, L8N 3R4, CA

(21) Appl. No.: 09/812,859

(22) Filed: Mar. 21, 2001

Related U.S. Application Data
(60) Provisional application No. 60/191,478, filed on Mar. 23, 2000.

(30) Foreign Application Priority Data
Mar. 22, 2000 (CA) 2,302,557

(51) Int. Cl. B22F 3/00; F16L 1/00; B65D 1/00; B32B 15/10; C22C 28/00

(52) U.S. Cl. 428/650; 428/546; 428/34.1; 29/527.3; 29/527.7; 29/432

(57) ABSTRACT

An aluminum alloy composition having an unusually high iron and silicon content, which is particularly improved by manganese additions contains preferably 0.5 to 1.1% wt Fe, preferably 0.3 to 0.7% wt Si, between 0.005 to 0.03% wt Ti, with the iron to silicon ratio maintained between 1.8 and 2.2:1. Most preferably, the alloy contains 0.10 to 0.8% wt manganese. A nominal alloy composition is as follows: 0.8% Fe, 0.4% Si, 0.015% Ti, and 0.4% Mn. The alloy is cast between a pair of cooling molds to produce a cast ingot, the ingot is hot rolled and subsequently cold rolled to thickness reductions of at least 25% and at most 70%, blanks are punched from the cold rolled sheet and the blanks are annealed at temperatures exceeding 350° C. but less than 525° C. and are subsequently deformed by impact extrusion to form long-necked cans which are stoved at temperatures as high as 275° C.

### FIELD OF THE INVENTION

This invention relates to an aluminum alloy composition and a process of preparing aluminum sheet for the fabrication of blanks used in the impact extrusion of long-necked can bodies.

### BACKGROUND OF THE INVENTION

In the automotive industry, it is common practice to add additives to oil in order to improve engine performance. The oil inlet to the engine is usually a small diameter tube and spaced from the interior boundary of the vehicle body so that it is difficult to reach. Containers for such additives are therefore made with long narrow necks. Containers made of synthetic plastic material are permeable to some additives and therefore some containers must be made of metal, depending on the nature of the fuel additive.

While long-necked containers made of aluminum alloys have been made by impact extrusion, as disclosed in U.S. Pat. No. 5,572,893, there are problems associated with the fabrication process which result in wrinkling and splitting of the metal during deformation of the neck portion, and the reject rate is unacceptably high.

Applicant has been supplying aluminum alloy blanks for impact extrusion of long-necked cans and has discovered that the scrap rate can be reduced from 10% to 1%, by changing its alloy composition and the process for producing the blanks supplied for impact extrusion.

### SUMMARY OF THE INVENTION

In accordance with the invention, an aluminum alloy composition is used which is characterized by an unusually high iron and silicon content and which is particularly improved by manganese additions.

The iron content is preferably 0.5 to 1.1% wt, the silicon content is preferably 0.3 to 0.7% wt, and titanium content is between 0.005 to 0.03% wt, with the iron to silicon ratio maintained between 1.8 and 2.2:1. Most preferably, the alloy contains 0.10 to 0.8% wt manganese.

A nominal alloy composition is as follows: 0.8% Fe, 0.4% Si, 0.015% Ti, and 0.4% Mn.

The alloy according to the invention is cast between a pair of cooling molds disposed face to face and rotated in contact with the alloy to produce a cast ingot, the ingot is hot rolled to a thickness of at least 25% and at most 70% and subsequently cold rolled to a thickness reduction of at least 25% and at most 70% to form a cold rolled sheet, blanks are punched from the cold rolled sheet and the blanks are annealed at temperatures exceeding 350° C. but less than 525° C.

Fabrication of long-necked cans by impact extrusion of the blanks is carried out in a normal manner, as taught in the prior art, and the disclosure of U.S. Pat. No. 5,572,893, in that respect, is herein incorporated by reference.

### BRIEF DESCRIPTION OF DRAWINGS

In order that the invention may be more clearly understood, a preferred embodiment is described below with reference to the accompanying drawings in which:

FIG. 1 is a flow chart of the process steps of the invention;

FIG. 2 is a schematic drawing showing a casting and rolling process in a method of producing blanks for impact extrusion according to the invention;

FIG. 3 is an illustration of a long-necked can body; and

FIGS. 4 and 5 are graphs showing the hardness variation for blanks made with a prior art alloy and the hardness variation, respectively for blanks made with an alloy in accordance with the invention.

### DESCRIPTION OF PREFERRED EMBODIMENT WITH REFERENCE TO THE DRAWINGS

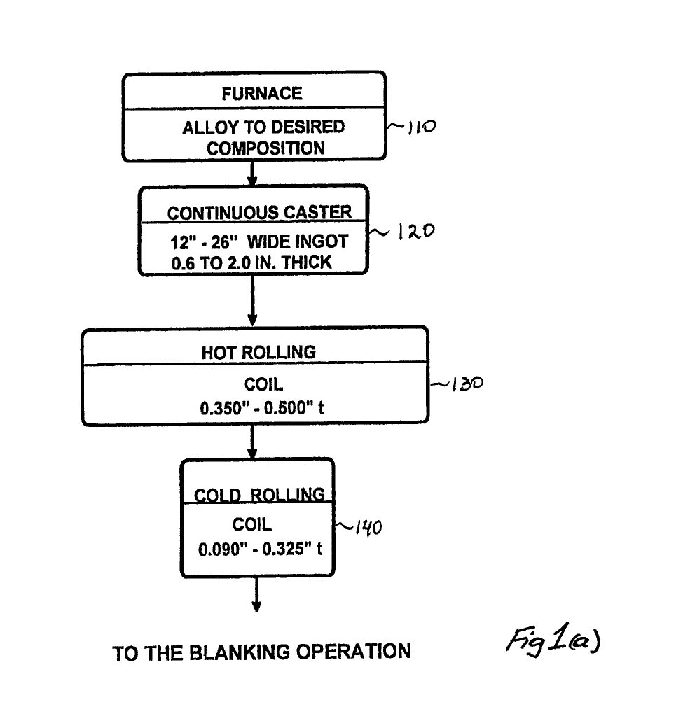

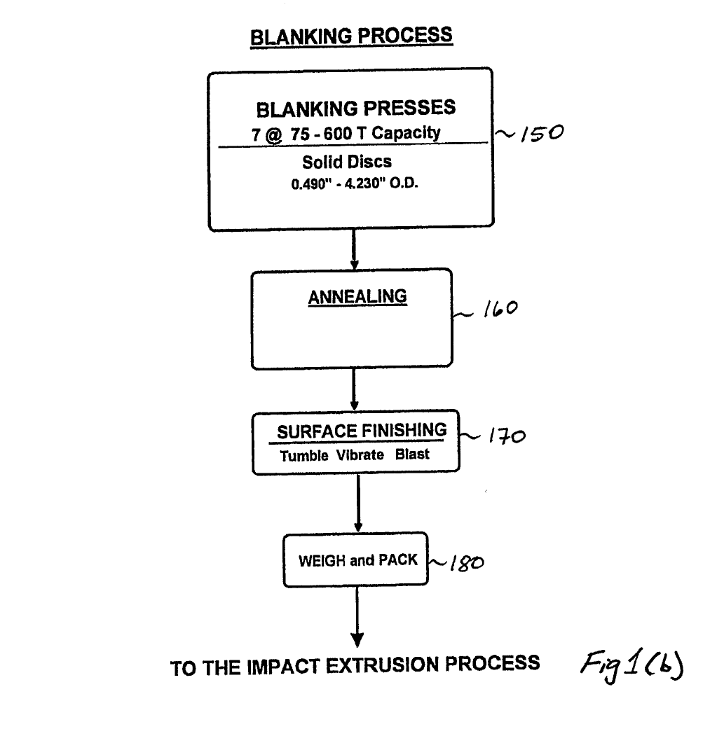

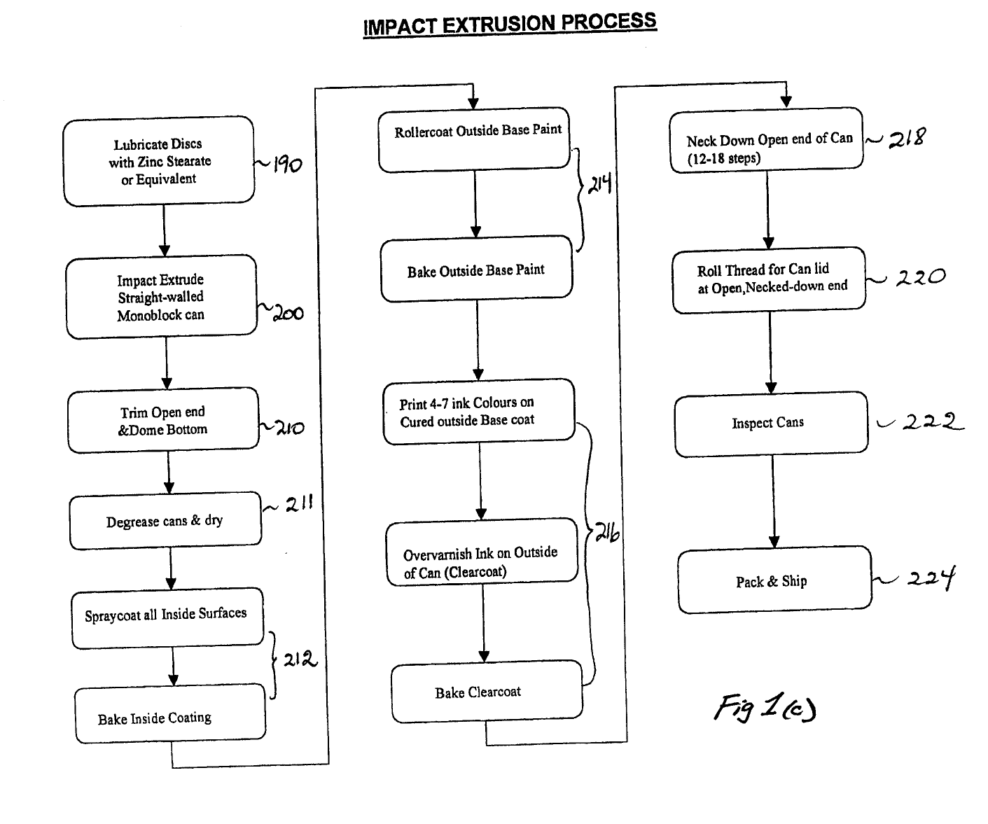

In the description which follows, reference will be made to FIG. 1 which is a flowchart showing the various processing steps for producing intermediary products as well as, ultimately, a long-necked can, in accordance with the invention. In accordance with the invention, the alloy required for producing blanks used for the impact extrusion of long-necked can bodies is formed in a continuous casting process which is schematically illustrated in FIG. 2 of the accompanying drawings and generally designated by reference numeral 20. The preferred alloy, in accordance with the invention, is prepared in a melt furnace 22 using source materials 24 which usually comprise ingots of predefined composition, recycled scrap, and alloy additives. This step is designated in FIG. 1 by reference numeral 110.

TABLE 1

| | Fe range | -nominal | Si range | -nominal | Ti range | -nominal | Mn range | -nominal |
|---|---|---|---|---|---|---|---|---|
| 1070 Alloy | | 0.15% | | 0.06% | | 0.01% | | |
| (prior art) | | | | | | | | |
| Alloy No. 1 | 0.5-1.1% | 0.8% | 0.3-0.7% | 0.4% | .005-0.03% | 0.015% | | |
| Alloy No. 2 | 0.5-1.1% | 0.8% | 0.3-0.7% | 0.4% | .005-0.03% | 0.015% | .10-0.8% | 0.4% |

Applicant has found two alloy compositions to be of use, and its components are indicated in Table 1. It will be seen that alloy No. 2 is similar in all respects to alloy No. 1 and additionally has a manganese content of up to 0.8 wt %. The alloys are characterized by a small amount of titanium which is added to the molten metal exiting the furnace 22 through launders 26 where it is filtered prior to entering a Hazelett caster 28 in which the alloy is frozen between a pair of water cooled belts or cooling molds disposed face to face and rotated in contact with the alloy to produce a cast ingot 30. It will be understood that the titanium addition is made to aid in grain refining the eventual alloy and that the actual additions of titanium will be made in the launders in order to create the required nucleating sites. The starting composition is a standard 1070 ingot and iron and silicon alloy additions are made, as required, to maintain an iron to silicon ratio of 2:1 or greater, within the range of 1.8 to 2.2:1, to produce alloy composition No. 1. In the case of alloy composition No. 2, manganese alloy additions are made to produce a casting 30 having a nominal manganese contain of 0.4 wt % which falls within a desirable range of 0.1 to 0.8 wt %.

The continuous casting step is designated in FIG. 1 by reference numeral 120 and typically produces an ingot having a width of 12 to 26 inches and a thickness of 0.6 to 2.0 inches. The ingot 30 exiting the caster 28 is aligned between two pairs of pinch rolls 32 before hot rolling in a two high hot roll mill 34 where the ingot is reduced in thickness by at least 25% and at most 70% to form a hot rolled plate 36 which is formed into a coil 38 and cut to length after exiting the hot roll mill between a pair of guide rolls 40 and a flying shear 42. The hot rolling and coiling of the hot rolled plate are designated by step 130 in FIG. 1. The coiled hot rolled plate 36 will typically have a thickness of 0.35 to 0.50 inches.

The hot rolled plate 36 is subsequently cold rolled, where it is further reduced by a commensurate amount of at least 25% and at most 70%, to form a cold rolled sheet. This step is designated by reference numeral 140 in FIG. 1.

After cold rolling, the cold rolled sheet is supplied to a blanking operation in which circular discs or blanks are punched from the cold rolled sheet using a press which will typically operate at a pressure of 75 to 600 tons to simultaneously produce a plurality of blanks each having an outside diameter ranging from 0.49 inches to 4.23 inches. The punching of blanks is designated by reference numeral 150 in FIG. 1. The blanks are subsequently annealed at a relatively high temperature of less than 525° C. but exceeding at least 250° C., and preferably higher than 350° C. The annealing step is designated by reference numeral 160 in FIG. 1. After annealing, the blanks are tumbled, vibrated or blasted with aluminum shot to roughen their surfaces in preparation for impact extrusion. This finishing operation is designated by reference numeral 170 in FIG. 1. Since impact extrusion is normally done off site from the production of the blanks, the blanks are usually weighed and packed in a final step designated by reference numeral 180 before leaving the premises.

The first step designated 190 in FIG. 1 during the impact extrusion process is to tumble the blanks in a lubricant such as zinc stearate powder. By roughing the blanks 170, the lubricant adheres more closely and uniformly to the surface of the blanks. The blanks are then supplied to an impact extrusion punch, step 200 in FIG. 1, where the metal will flow in the space defined between an outer die and an internal punch which impacts on the blank at a very high speed and pressure, causing the metal of the blank to flow upwardly and form a thin walled container. The containers are subsequently trimmed at an open end and a dome is formed in the bottom. The trimming and forming step is designated by referenced numeral 210 in FIG. 1. Trimming is followed by degreasing and drying 211 and by three consecutive steps 212, 214 and 216, in which the inside of the open containers is coated with varnish, and stoved or cured at a temperature of 270° C., the outside is subsequently coated and also cured at a temperature of 270° C. and finally 4 to 7 colours are applied to the outside of the container together with a final protective clear coat which is cured at 270° C.

Finally, a necking operation 218 is performed which may comprise up to 20 forming stations for gradually shaping and elongating the open end of the can formed in the impact extrusion step 200. In a final necking station 220, an external thread will be formed so that the can may cooperate with a threaded closure. Cans are finally given an inspection 222, and packed for shipping 224.

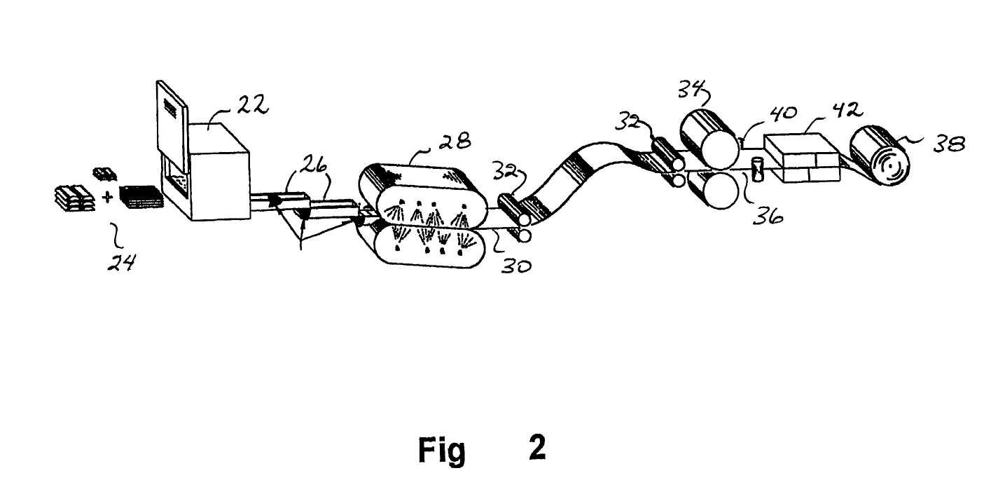

A typical long necked can having a threaded end of the kind under discussion is schematically illustrated in FIG. 3 and designated by reference numeral 44.

In use, it has been found that the scrap rate which may be as high as 20% and at least 10% using a standard 1070 alloy is reduced to less than 2% and may be as low as 1% using the new alloy compositions according to the invention. It is expected that the relatively high iron content provides better ductility so that the material can withstand the cold work deformation produced during impact extrusion which may be as high as 85%, and yet be deformed further during a necking operation. It will be understood that many prior art alloy compositions which broadly include the claimed alloy compositions of the subject invention are directed to uses in which no high ductility is required, for example, in the case of printing plates.

With the further addition of manganese to the alloy composition, the mechanical properties of the cans, for example the burst pressure or pressure at which a can will burst and therefore fail, is substantially increased. As a result, the stoving temperatures used to cure the various coatings applied to the cans in steps 212, 214, 216, and which desirably are as high as 275° C., can be maintained without a commensurate decrease in the yield strength of the can. The alternative would be to lower the stoving temperature to 240° C. and this would preserve the mechanical properties of the can but curing of the desired coatings would not be complete. Applicant has also found that the manganese addition improves the dent resistance of the formed cans.

In practice, it has been found that a yield strength of 19,500 psi will be achieved with alloy No. 1 at stoving temperatures of 230° C. but the alloy has an unacceptably low yield strength of 17,500 psi at stoving temperatures of 270° C. which in many applications, will not meet industry specifications. However, by the addition of manganese to form alloy No. 2, a stoving temperature of 270° C. made be used and still a yield strength of 19,500 psi will be achieved.

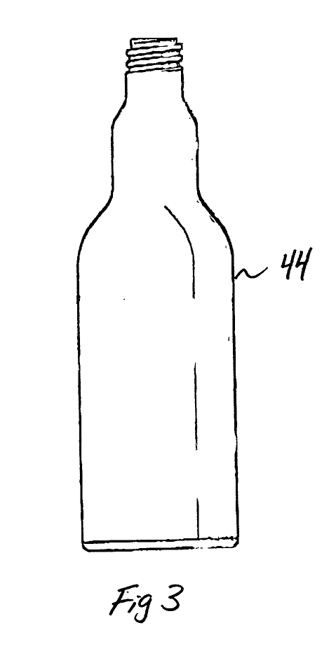

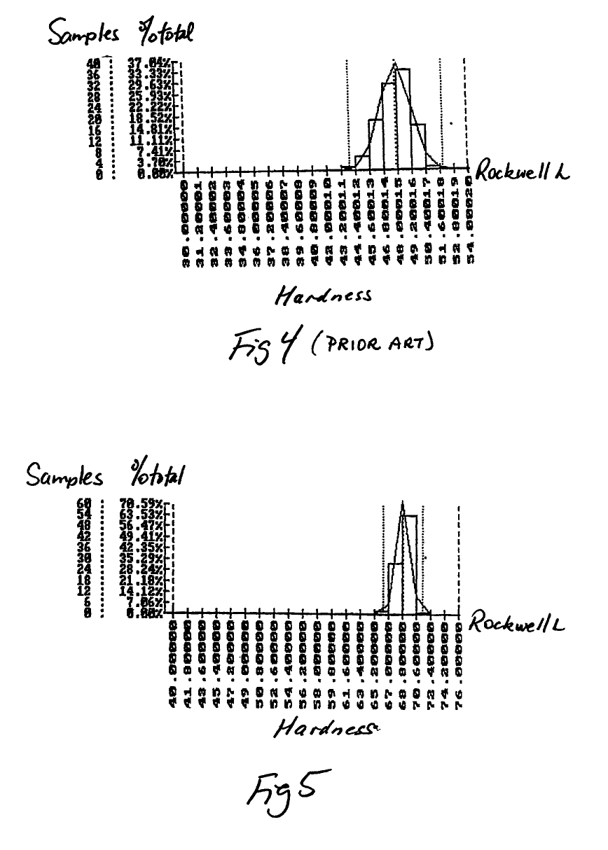

While the alloy composition used to form the blanks used in impact extrusion is critical, the process of forming the blanks is equally important. It will be appreciated that deformation of the cast ingot and of the hot rolled plate during cold rolling is limited to at most 70% and will normally be in the range of 40 to 60% which is well below the 90% cold working achieved in prior art processes such as that taught in U.S. Pat. No. 3,571,910 to Reynolds Metals Company and deformation of at least 75% in the process taught by Swiss Aluminum Limited in U.S. Pat. No. 4,483,719. The processing of the blanks is further characterized by a high annealing temperature approaching 525° C. which far exceeds the prior art temperatures which are usually in the neighbourhood 350° C. As illustrated in the accompanying FIGS. 4 and 5, it will be seen that the hardness of the blanks made with alloy No. 1 according to the invention (FIG. 5) actually increases although the ductility is greater than with the 1070 alloy. It will also be observed that the hardness range is significantly narrower so that there is less variation in the hardness from one batch of blanks to another with the result that the quality of the resultant can produced by impact extrusion is more consistent and there is a corresponding reduction in the amount of scrap.

It will be understood that several variations may be made to the above described preferred embodiments of the invention within the scope of the appended claims and that such variations will still embody the essential features of the invention, as described above.

1. A process for the preparation of aluminum sheet suitable for the fabrication of blanks used for the impact extrusion of long-necked can bodies, the process comprising:
providing an aluminum base alloy having 0.5 to 1.1 wt % iron, 0.3 to 0.7 wt % silicon, 0.005 to 0.03 wt % titanium, and the balance aluminum and unavoidable impurities, the ratio of iron to silicon being between 1.8 to 2.2:1,
casting said alloy between a pair of cooling molds disposed face to face and rotated in contact with the alloy to produce a cast ingot,
rolling the cast ingot to a thickness reduction of at least 25% and at most 70% to form a hot rolled plate;
cold rolling the hot rolled plate to a thickness reduction of at least 25%, and at most 70% to form a cold rolled sheet,
punching blanks from said cold rolled sheet, and
annealing said blanks at a temperature of less than 525° C. and exceeding 350° C.

2. A process according to claim 1 in which the alloy additionally contains 0.10 to 0.8 wt % manganese.

3. A process according to claim 1 in which the alloy has a nominal composition of 0.8 wt % Fe, 0.4 wt % Si, 0.015 wt % Ti, the balance being aluminum and unavoidable impurities.

4. A process according to claim 1 in which the alloy has a nominal composition of 0.8 wt % Fe, 0.4 wt % Si, 0.015 wt % Ti, and 0.4 wt % Mn, the balance being aluminum and unavoidable impurities.

5. A process for the preparation of aluminum sheet suitable for the fabrication of blanks used for the impact extrusion of long-necked can bodies, the process comprising:
providing an aluminum base alloy having 0.5 to 1.1 wt % iron, 0.3 to 0.7 wt % silicon, 0.005 to 0.03 wt % titanium, 0.10 to 0.8 wt % manganese, and the balance aluminum and unavoidable impurities, the ratio of iron to silicon being between 1.8 to 2.2:1,
casting said alloy between a pair of cooling molds disposed face to face and rotated in contact with the alloy to produce a cast ingot,
rolling the cast ingot to a thickness reduction of at least 25% and at most 70% to form a hot rolled plate;
cold rolling the hot rolled plate to a thickness reduction of at least 25%, and at most 70% to form a cold rolled sheet,
punching blanks from said cold rolled sheet, and
annealing said blanks at a temperature of less than 525° C. and exceeding 350° C.

6. A process according to claim 5 in which the alloy has a nominal composition of 0.8 wt % Fe, 0.4 wt % Si, 0.015 wt % Ti, and 0.4 wt % Mn, the balance being aluminum and unavoidable impurities.

7. A long-necked can body made by impact extrusion of aluminum alloy blanks, the aluminum alloy having
0.5 to 1.1 wt % iron,
0.3 to 0.7 wt % silicon,
0.005 to 0.03 wt % titanium,
the balance being aluminum and unavoidable impurities, and the ratio of iron to silicon being between 1.8 and 2.2:1.

8. A long-necked can body according to claim 7 having a nominal composition of 0.8 wt % Fe, 0.4 wt % Si, 0.015 wt % Ti, the balance being aluminum and unavoidable impurities.

9. A long-necked can body made by impact extrusion of aluminum alloy blanks, the aluminum alloy having
0.5 to 1.1 wt % iron,
0.3 to 0.7 wt % silicon,
0.005 to 0.03 wt % titanium,
0.10 to 0.8 wt % manganese,
the balance being aluminum and unavoidable impurities, and the ratio of iron to silicon being between 1.8 and 2.2:1.

10. A long-necked can body according to claim 7 having a nominal composition of 0.8 wt % Fe, 0.4 wt % Si, 0.015 wt % Ti, 0.4 wt % Mn the balance being aluminum and unavoidable impurities.
